(19) United States
(12) Patent Application Publication
(10) Pub. No.: US 2008/0198115 A1
(43) Pub. Date: Aug. 21, 2008

(54) Liquid Crystal Display Overdrive Accuracy Adjustment Device And Method

(76) Inventors: Chang-Cheng Lin, Taipei (TW); Yuh-Ren Shen, Tai-Nan (TW); Cheng-Chung Peng, Hsin-Chu (TW)

Correspondence Address: LIN & ASSOCIATES INTELLECTUAL PROPERTY, INC., P.O. BOX 2339, SARATOGA, CA, 95070-0339, US

(21) Appl. No.: 11/675,089

(22) Filed: Feb. 15, 2007

(51) Int. Cl. G09G 3/36

(52) U.S. Cl. 345/89

(57) ABSTRACT

An overdrive accuracy adjustment device and method for use in liquid crystal display panel is presented. According to a current grayscale value of a pixel in an awaiting to be displayed image and a previous grayscale value of the corresponding pixel in an already-displayed image, the corresponding overdrive grayscale value is found from the look-up table. In order to more efficiently use the limited storage capacity of the look-up table as well as improving the accuracy of the overdrive, in accordance to the physical characteristics of the liquid crystal display panel in particular (in particular to the grayscale values which often required the overdrive), the gap size between the current grayscale values and/or the previous grayscale values with each other should be adjusted in the look-up table, without having to increase the quantity of the overdrive grayscale values stored in the look-up table.

### BACKGROUND OF THE INVENTION

1. Field of the Invention

The present invention relates generally to a liquid crystal display overdrive device and method thereof, and in particular to an overdrive accuracy adjustment device and method thereof for obtaining improved response speed of the liquid crystal display and also better image quality.

2. The Prior Arts

Referring to FIG. 1A to FIG. 1B, a conventional drive method is shown in FIG. 1A to FIG. 1B. As shown in FIG. 1A in the conventional drive method, when a grayscale value of g₀ is switched into g₁ at time t₀, the corresponding pixel brightness is switched from Y₀ into Y₁. However, the response time during the switching of the pixel brightness from Y₀ to Y₁ is exceedingly prolonged such that the pixel brightness cannot reach the predetermined Y₁ within a pixel period.

As shown in FIG. 1B, the overdrive method has been disclosed to overcome the problem as mentioned above. The pixel brightness can reach the predetermined Y1 within a pixel period. In this pixel period, the overdrive grayscale value (g₁′) required by the overdrive would be related to the previous grayscale value (g₀) and the current grayscale value (g₁).

Referring to FIG. 2A to FIG. 2C, a conventional drive device is shown in FIG. 2A to FIG. 2C. As shown in FIG. 2A, a conventional drive device includes a look-up table 10 for the 3 gamma values, a memory controller 12, a memory 14, and an overdrive module 16. The conventional device processed by the overdrive module 16 can be the overdrive as shown in FIG. 1B. The look-up table 10 (for 3 gamma values or the gamma curve) converts the grayscale values received to be as the proper drive voltages. And then the memory controller 12 receives the pixel values from the look-up table 10 and stores the pixel values inside the memory 14. The overdrive module 16 receives the current grayscale value (g₁) and the previous grayscale value (g₀) from the look-up table 10 (holding the gamma values) and the memory controller 12, respectively, to look up the corresponding overdrive grayscale value (g₁′) in a built-in look-up table 18, and inputs the results inside a liquid crystal display panel.

As shown in FIG. 2B, the look-up table 18 includes a plurality of current grayscale values and a plurality of previous grayscale values which are mutually corresponded to a plurality of overdrive grayscale values. Taking the 256 grayscale as an example, 256×256 overdrive grayscale values would be stored in the look-up table 18. However, under general applications for the sake of reducing storage costs, the quantity of the overdrive grayscale values stored in the look-up table 18 may be only 21×21. In other words, only overdrive grayscale values which are corresponding with a plurality of current grayscale values and a plurality of previous grayscale values, and having grayscale values of 0, 4, 8, 12 . . . are stored. If it is required to look up the current grayscale value for 21 and the previous grayscale value for 6 as shown in FIG. 2C, interpolation operation is performed.

However, the overdrive grayscale values (g₁′) are indeed originally of actual values being measured, and are not determined from using equations. Through the use of the interpolation operation as mentioned above, a problem regarding inaccuracy is resulted.

### SUMMARY OF THE INVENTION

A primary objective of the present invention is to provide an overdrive accuracy adjustment device and method thereof, which in particular is in accordance to the physical characteristics of the liquid crystal display panel (in particular to the grayscale which often required the overdrive). Without having to increase the quantity of overdrive grayscale values stored in the look-up table, the gap size between a plurality of current grayscale values and/or a plurality of previous grayscale values with relation to each other should be adjusted in the look-up table, and thereby more efficiently utilizing the limited storage capacity of the look-up table, and improve upon the accuracy on the overdrive.

Based on the objective as mentioned above in the overdrive accuracy adjustment device of the present invention, the device includes a look-up table (having 3 gamma values), a memory controller, an overdrive module, and an adjustable gamma module which can be connected with the look-up table, the memory controller, or the overdrive module electrically. The look-up table converts a current grayscale value of a pixel received from awaiting pictures, which is yet to be displayed, into an appropriate drive voltage using the gamma curve. The memory controller receives the current grayscale value from the look-up table, which includes the 3 gamma values; and the memory controller stores the current grayscale value in a memory, and the current grayscale value is then to be defined as a previous grayscale value. The overdrive module is electrically connected with the memory controller and the look-up table, and it includes a plurality of current grayscale values and a plurality of previous grayscale values which are mutually corresponded in one look-up table including a plurality of overdrive grayscale values. According to the current grayscale value of a pixel in an awaiting to be displayed image and the previous grayscale value of the corresponding pixel in an already-displayed image, the corresponding overdrive grayscale value is picked out from the look-up table, and then is to be inputted in the liquid crystal display panel. The adjustable gamma module is respectively electrically connected with the look-up table (of 3 gamma values) and the memory controller; and the adjustable gamma module includes a plurality of adjustable data. Each adjustable data is using an original grayscale value corresponding to the adjusted grayscale value inside the look-up table to adjust the gaps between the current grayscale values with each other in the look-up table, without increasing the quantity of the overdrive grayscale values stored in the look-up table, and using the adjusted data for adjusting the gap size between the current grayscale values.

### BRIEF DESCRIPTION OF THE DRAWINGS

The present invention will be apparent to those skilled in the art by reading the following detailed description of a preferred embodiment thereof, with reference to the attached drawings, in which:

FIG. 1A to FIG. 1B are a plurality of schematic views showing a conventional drive method;

FIG. 2A to FIG. 2C are a plurality of schematic views showing a conventional drive device;

FIG. 3A to FIG. 3C are a plurality of schematic views showing an overdrive accuracy adjustment device according to a first embodiment of the present invention; and

FIG. 4A to FIG. 4B are a plurality of schematic views showing another overdrive accuracy adjustment device according to a second embodiment of the present invention.

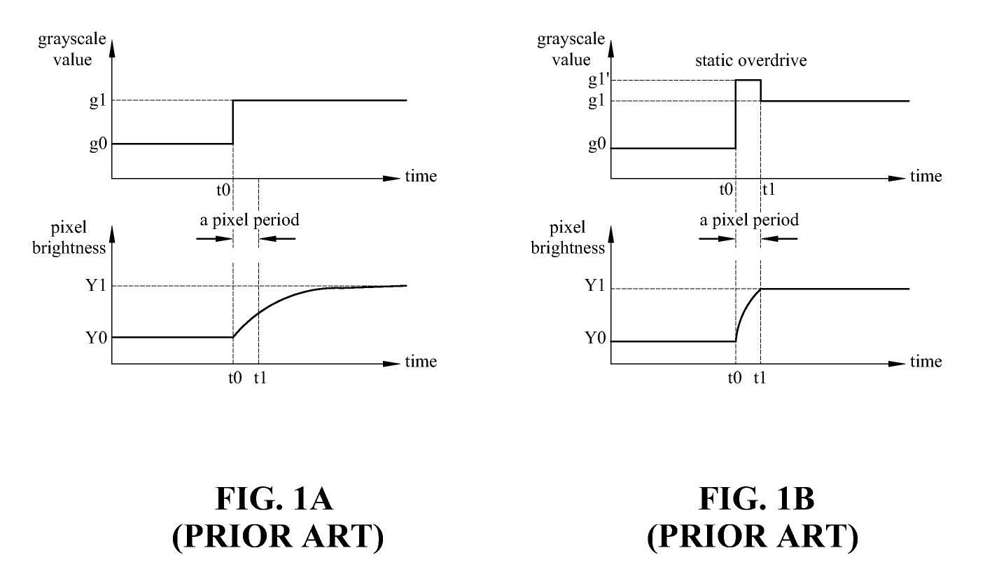

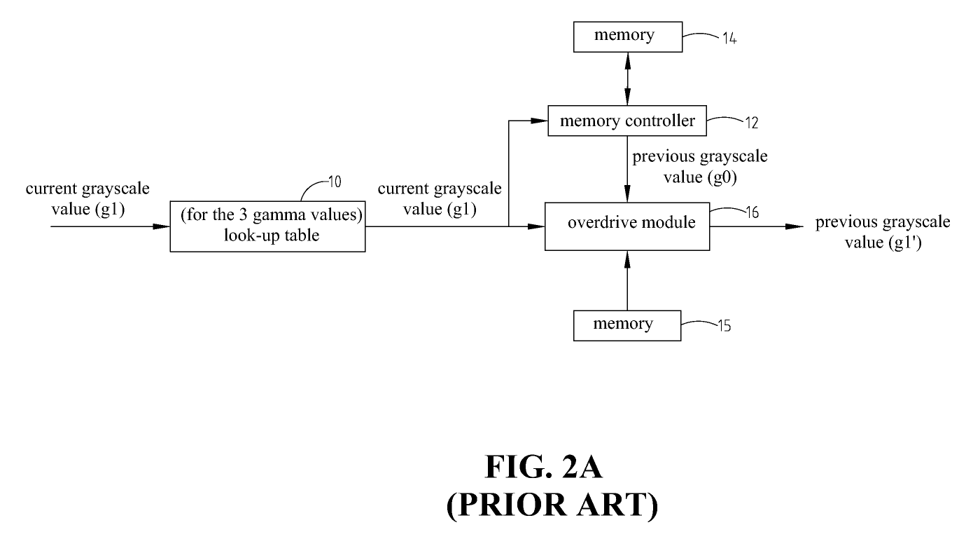

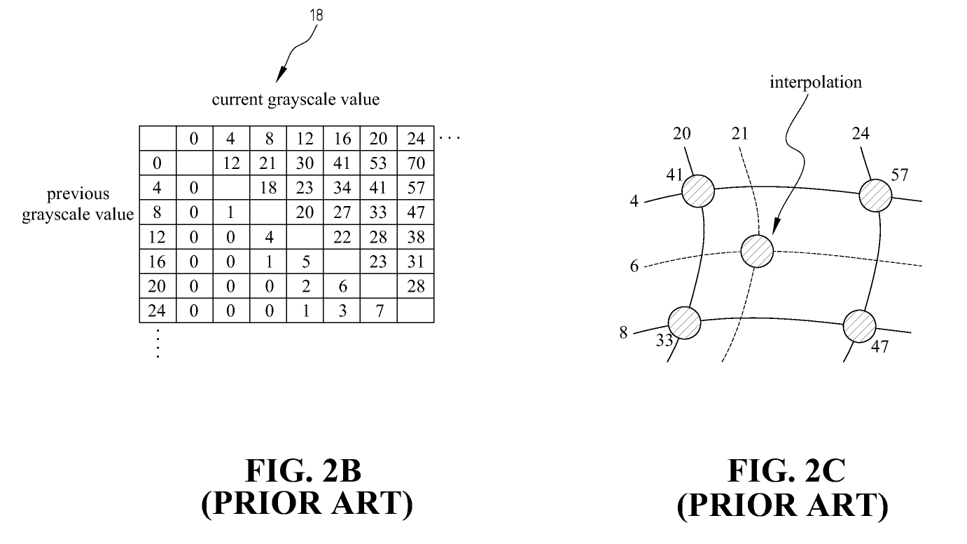

### DETAILED DESCRIPTION OF THE PREFERRED EMBODIMENT

In the overdrive accuracy adjustment method of the present invention, the look-up table remains to be used for obtaining the overdrive grayscale values. The look-up table remains to include a plurality of current grayscale values and a plurality of previous grayscale values which are mutually corresponded to a plurality of overdrive grayscale values. When performing the overdrive, the corresponding overdrive grayscale value can be picked out of the look-up table according to the current grayscale value of a pixel in an awaiting to be displayed image and the previous grayscale value of the corresponding pixel in an already-displayed image. Therefore, in order to use the limited storage capacity of the look-up table more efficiently without increasing the quantity of the overdrive grayscale values, and also refraining from relying on the interpolation operation for estimating the overdrive grayscale values for improving the accuracy of the overdrive, a plurality of embodiments are provided. According to the physical characteristics of the liquid crystal display panel in particular (in particular to the grayscale values which often required the overdrive), the gaps between a plurality of current grayscale values and/or previous grayscale values with respect to each other should be adjusted by using the overdrive accuracy adjustment device and method thereof in the present invention to thereby more efficiently using the limited storage capacity of the look-up table as well as improving the accuracy of the overdrive. In below, there are two embodiments for illustrating the method for adjusting the gap sizes between a plurality of current grayscale values and/or the previous grayscale values with respect to each other, respectively.

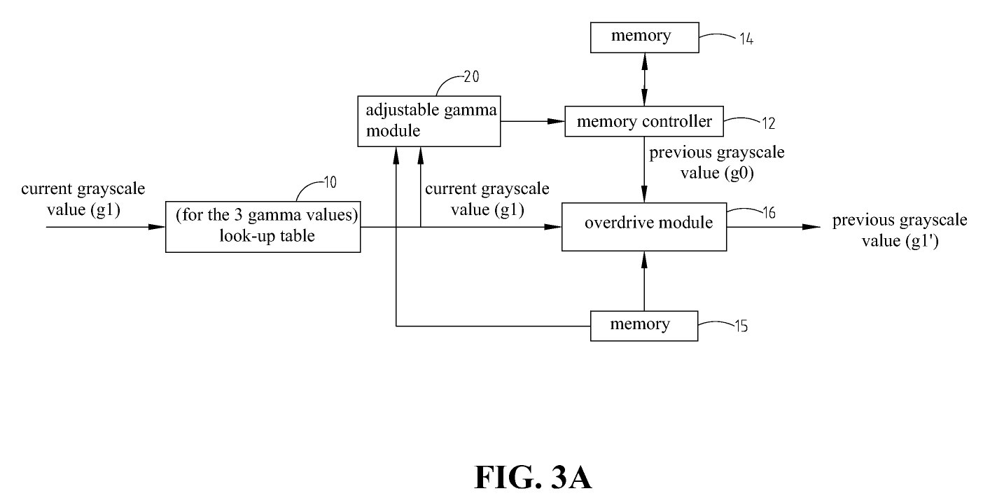

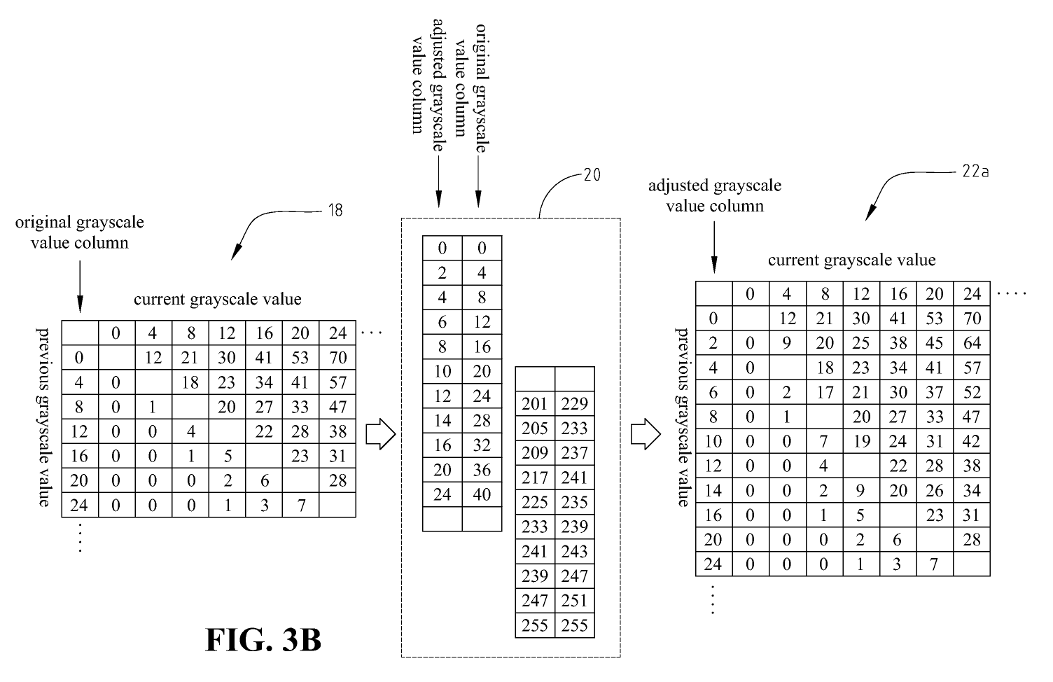

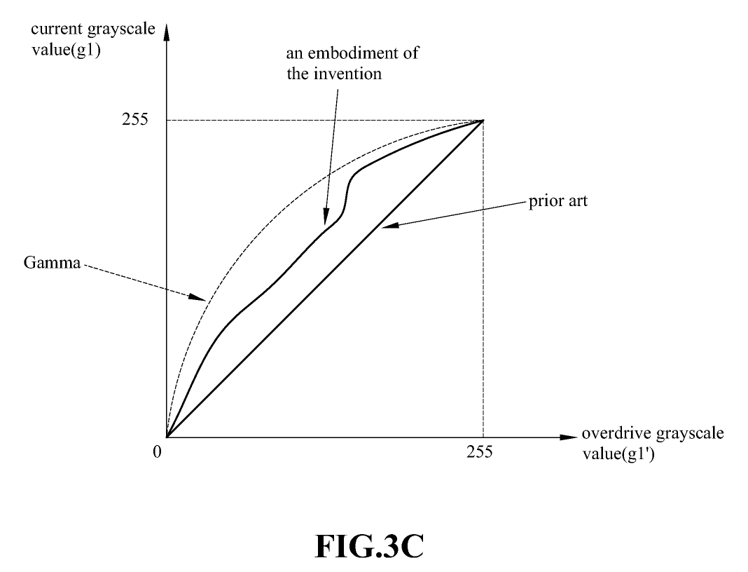

Referring to FIG. 3A to FIG. 3C, the overdrive accuracy adjustment device according to a first embodiment of the present invention is shown in FIG. 3A to FIG. 3C. As shown in FIG. 3A, the drive device of the present invention includes a look-up table 10 (including 3 gamma values), a memory controller 12, a memory 14, and an overdrive module 16, and also can further include an adjustable gamma module 20. The adjustable gamma module 20 is electrically connected with the look-up table 10 (having 3 gamma values) and the memory controller 12, respectively.

When the current grayscale value of the pixel in the awaiting to be displayed image has been received, the look-up table 10 or the gamma curve can be used to convert the current grayscale value to the proper drive voltage. Then, the current grayscale value from the look-up table 10 is transmitted to the memory controller 12 through the adjustable gamma module 20; and the current grayscale value, received by the memory controller 12, is to be stored in the memory 14. The current grayscale value is then defined as the previous grayscale value. Similar as in conventional technology, the overdrive module 16 remains to be electrically connected with the memory controller 12 and the look-up table 10, respectively; and the overdrive module 16 includes the look-up table as mentioned above. The overdrive module 16 remains to look up the corresponding overdrive grayscale values from the look-up table according to the current grayscale value of one of the pixels in the awaiting to be displayed image and the previous grayscale value of the corresponding pixel in the already-displayed image, and the corresponding overdrive grayscale values are found or determined from the look-up table 10, and the overdrive grayscale values are inputted into the liquid crystal display panel.

In order to improve the accuracy of the overdrive, the adjustable gamma module 20 can include a plurality of adjustable data as shown in FIG. 3B. Each adjusted data is to be made by comparing a column of the original grayscale values in the look-up table 18 with a column of the grayscale values that had been adjusted in the look-up table 22a one by one. Thus, the adjustable gamma module 20 can adjust the gap size in between the current grayscale values in the look-up table 18 using the adjusted data, without increasing the total quantity of the overdrive grayscale values stored in the look-up table 22a. In addition, the corresponding overdrive grayscale values are to be filled in the added fields.

In detail, according to the results of the experiments when a particular liquid crystal display panel is to be defined in the high and low grayscale values, the overdrive grayscale values are often needed to be looked up. In order to reduce the calculating of overdrive grayscale values by using the interpolation operations, the gap densities of the current grayscale values in the high and low grayscale values are increased in particular. The original 0, 4, 8, 12 . . . is adjusted to 0, 2, 4, 6, 8, 10, 12 . . . , so as to form the comparative diagram showing the current grayscale values (g₁) and the overdrive grayscale values (g₁′), as shown in FIG. 3C. An important fact is that regardless whether it is the columns/rows of the grayscale values adjusted or the columns/rows of the original grayscale values, there is no particular mode for defining the gap sizes, which are mainly adjusted based upon practical requirements.

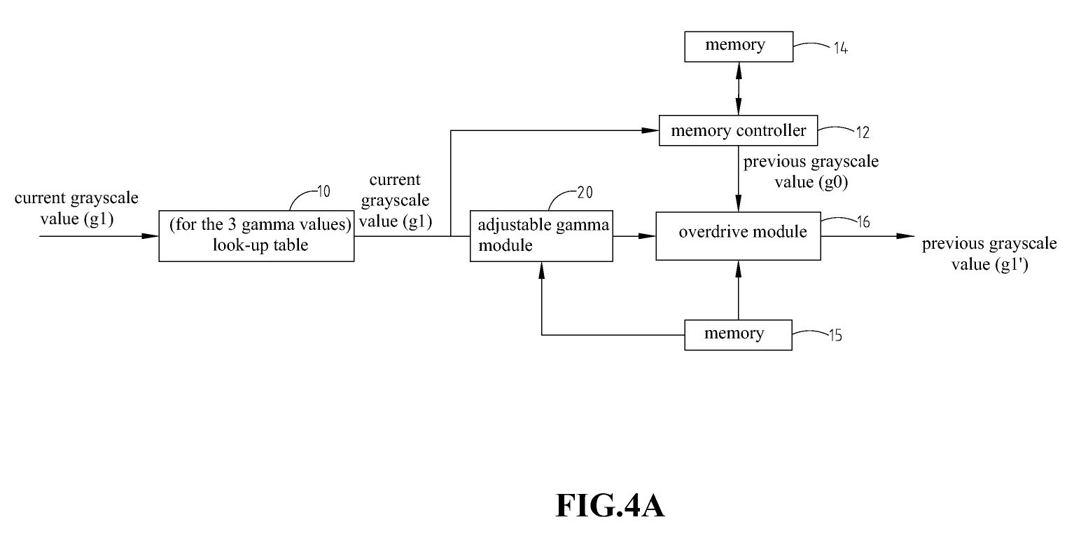

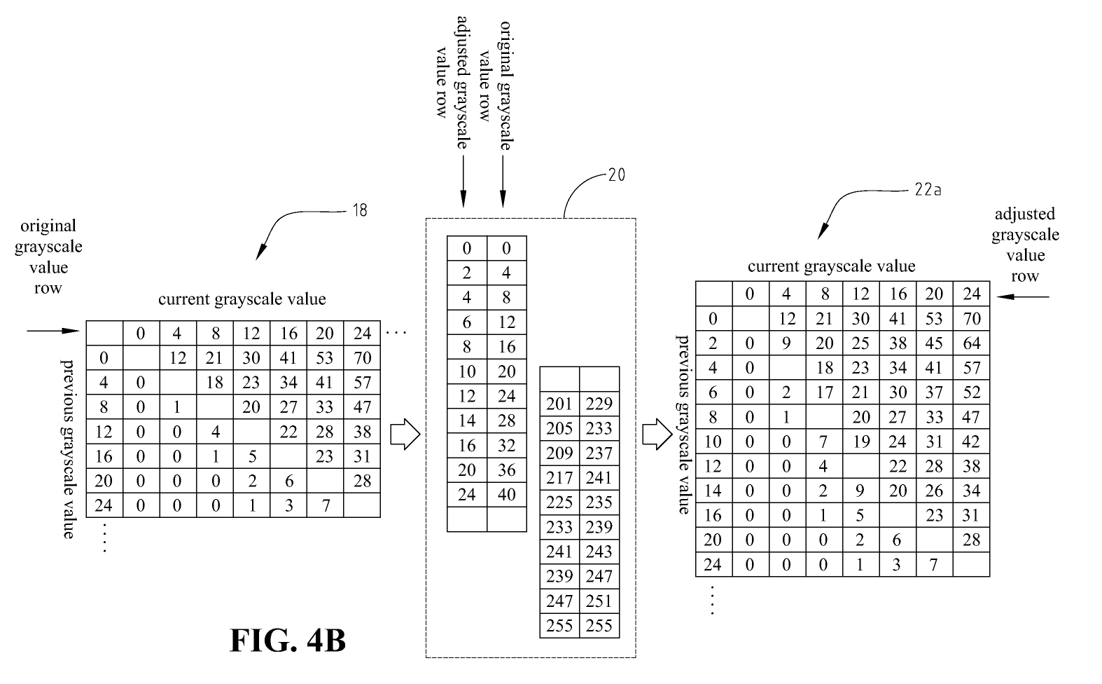

Referring to FIG. 4A to FIG. 4B, the overdrive accuracy adjustment device and method thereof according to a second embodiment of the present invention is shown in FIG. 4A to FIG. 4B. As shown in FIG. 4A, the drive device of the present invention also includes a look-up table 10 (having 3 gamma values), a memory controller 12, a memory 14, an overdrive module 16, and also further to include an adjustable gamma module 20. The adjustable gamma module 20 is electrically connected with the look-up table 10 and the overdrive module 16, respectively.

As shown in FIG. 4B, in the second embodiment, the adjustable gamma module 20 adjusts the gaps between the previous grayscale values with respect to each other in the look-up table 18 using the adjusted data (an original grayscale value row is corresponding to an adjusted grayscale value row one by one) so as to form the look-up table 22b.

In the overdrive accuracy adjustment method for liquid crystal display panel, besides using the adjustable gamma module 20 for adjusting the gap densities between the current grayscale values and/or the previous grayscale values, the accuracy gap between the current grayscale values and/or the previous grayscale values can be adjusted dynamically in the original look-up table 18, in accordance with the physical characteristics of the liquid crystal display panel directly, according to the current grayscale value of a pixel in an awaiting to be displayed image and the previous grayscale value of the corresponding pixel in an already-displayed image so as to determine the corresponding overdrive grayscale values, and to input the overdrive grayscale values into the liquid crystal display panel. The corresponding overdrive grayscale values are of non-equidistance values. In other words, whether by dynamic adjustments using the LUT or performing adjustments through using equations for calculations do not go beyond the spirits of the present invention.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An overdrive accuracy adjustment method for use in liquid crystal display panel for determining a corresponding overdrive grayscale value from a look-up table according to a current grayscale value of a pixel in an awaiting to be displayed image and a previous grayscale value of the corresponding pixel in an already-displayed image; the look-up table comprising a plurality of current grayscale values and a plurality of previous grayscale values with each other mutually corresponding to a plurality of overdrive grayscale values, respectively, wherein, according to the physical characteristics of the liquid crystal display panel, a gap size between the current grayscale values and the previous grayscale values with respect to each other is adjusted, without increasing the quantity of the overdrive grayscale values stored in the look-up table.

2. An overdrive accuracy adjustment method for use in the liquid crystal display panel, wherein in accordance with the physical characteristics of the liquid crystal display panel, according to a current grayscale value of a pixel in an awaiting to be displayed image and a previous grayscale value of the corresponding pixel in an already-displayed image, the accuracy gap between the current grayscale value and the previous grayscale value is adjusted dynamically in an original look-up table so as to determine a corresponding overdrive grayscale value, and then the overdrive grayscale value is inputted into the liquid crystal display panel.

3. The overdrive accuracy adjustment method for use in the liquid crystal display panel as claimed in claim 2, wherein the accuracy gap between the current grayscale value and the previous grayscale value adjusted dynamically in an original look-up table are of non-equidistance.

4. An overdrive accuracy adjustment device for use in the liquid crystal display panel, comprising:
a look-up table, for looking up gamma values, and converting a current grayscale value of a pixel received from an awaiting to be displayed image to a proper drive voltage;
a memory controller, receiving the current grayscale value from the look-up table, storing the current grayscale value in a memory, and defining the current grayscale value to be as a previous grayscale value;
an overdrive module, electrically connecting with the memory controller and the look-up table, and comprising the look-up table formed by a plurality of current grayscale values and a plurality of previous grayscale values with each other mutually corresponding to a plurality of overdrive grayscale values, respectively, according to the current grayscale value of one of the pixels in the awaiting to be displayed image and the previous grayscale value of the corresponding pixel in the already-displayed image, and the corresponding overdrive grayscale value is found from the look-up table and is inputted into the liquid crystal display panel; and
an adjustable gamma module, electrically connecting with the look-up table and the memory controller, and comprising a plurality of adjusted data, and each adjusted data is used for adjusting the gap size between the current grayscale values with each other in the look-up table, and the adjusted data is made by comparing a row of the original grayscale values with a row of the grayscale values that have been adjusted one by one, without increasing the quantity of the overdrive grayscale values stored in the look-up table.

5. An overdrive accuracy adjustment device for use in liquid crystal display panel, comprising:
a look-up table for looking up gamma values, and converting a current grayscale value of a pixel received from an awaiting to be displayed image to a proper drive voltage;
a memory controller, receiving the current grayscale value from the look-up table and storing the current grayscale value in a memory, and defining the current grayscale value to be as a previous grayscale value;
an overdrive module, electrically connecting with the memory controller and the look-up table, and comprising a look-up table formed by a plurality of current grayscale values and a plurality of previous grayscale values with each other mutually corresponding to a plurality of overdrive grayscale values, respectively, according to the current grayscale value of one of the pixels in the awaiting to be displayed image and the previous grayscale value of the corresponding pixel in the already-displayed image, and the corresponding overdrive grayscale value is found from the look-up table and is inputted into the liquid crystal display panel; and
an adjustable gamma module, electrically connecting with the look-up table and the overdrive module, and comprising a plurality of adjusted data, and each adjusted data is used for adjusting the gap size between the previous grayscale values with each other in the look-up table, and the adjusted data is made by comparing a row of the original grayscale values with a row of the grayscale values that have been adjusted one by one, without increasing the quantity of the overdrive grayscale values stored in the look-up table.
